(19) United States
(12) Patent Application Publication
(10) Pub. No.: US 2015/0026725 A1
(43) Pub. Date: Jan. 22, 2015

(54) ELECTRONIC DEVICE, DISPLAY METHOD, AND COMPUTER PROGRAM PRODUCT

(71) Applicants: KABUSHIKI KAISHA TOSHIBA, Tokyo (JP); Toshiba Lifestyle Products & Services Corporation, Tokyo (JP)

(72) Inventors: Yosuke TAKAHASHI, Tokyo (JP); Munehiro Tokikura, Kawasaki Kanagawa (JP)

(21) Appl. No.: 14/470,830

(22) Filed: Aug. 27, 2014

Related U.S. Application Data
(63) Continuation of application No. PCT/JP2013/069531, filed on Jul. 18, 2013.

(51) Int. Cl. H04N 21/81; H04N 21/45; H04N 21/414; H04N 21/472; H04N 21/482; H04N 21/431; H04N 21/466

(52) U.S. Cl. CPC H04N 21/8173; H04N 21/4312; H04N 21/4532; H04N 21/4668; H04N 21/472; H04N 21/4826; H04N 21/41407; H04N 21/8146
USPC 725/40; 725/46

(57) ABSTRACT

According to one embodiment, an electronic device includes an input controller to designate a plurality of first programs that a user wants to view among a plurality of programs; a processor to execute an application for displaying information on a first program to be broadcast in a first period among the plurality of the first programs, the first period being determined according to a current time; and a display processor to display number of first programs to be broadcast in the first period on a screen for activating the application.

### CROSS-REFERENCE TO RELATED APPLICATIONS

This application is a continuation of international application No. PCT/JP2013/069531, filed Jul. 18, 2013, which designates the United States, the entire contents of which are incorporated herein by reference.

### FIELD

An embodiment described herein relates generally to an electronic device, a display method, and a computer program product.

### BACKGROUND

Conventionally, there has been known an application that presents a user with program information on programs scheduled to be broadcast. Such a conventional application, when the user finds a program that he/she wants to view, registers the program as a to-be-viewed program, enables the registered to-be-viewed program to be easily detected when a program information list is displayed, and gives notice to the user before the to-be-viewed program is broadcast.

In such an application, it is desired to make a user accurately recognize the presence of a to-be-viewed program.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a network configuration of a program information distribution system and a hardware configuration of a mobile terminal according to an embodiment;

FIG. 2 is an exemplary block diagram illustrating a functional configuration of the mobile terminal according to the present embodiment;

FIG. 3 is an exemplary diagram illustrating an example of a program information DB of the present embodiment;

FIG. 4 is an exemplary diagram illustrating an example of a state in which the number of to-be-viewed programs is displayed on an activation icon of a program notification application in the present embodiment;

FIG. 5 is an exemplary diagram illustrating extraction of programs that are registered as to-be-viewed programs in FIG. 3 in the present embodiment;

FIG. 6 is an exemplary diagram illustrating a change in badge display of the number of to-be-viewed programs in the example in FIG. 3 in the present embodiment;

FIG. 7 is an exemplary diagram illustrating an example of transition of the badge display on the activation icon of the program notification application in the present embodiment;

FIG. 8 is an exemplary diagram illustrating another example of transition of the badge display on the activation icon of the program notification application in the present embodiment;

FIG. 9 is an exemplary flowchart illustrating the procedure of a to-be-viewed program registration process of the present embodiment;

FIG. 10 is an exemplary diagram illustrating an example of a program information list screen in the present embodiment;

FIG. 11 is an exemplary diagram illustrating an example of a registered people list screen in the present embodiment;

FIG. 12 is an exemplary diagram illustrating an example of a selection screen for a registered person adding method in the present embodiment;

FIG. 13 is an exemplary diagram illustrating an example of a screen for designating deletion of a registered person in the present embodiment;

FIG. 14 is an exemplary diagram illustrating an example of a high-profile people list screen in the present embodiment;

FIG. 15 is an exemplary diagram illustrating an example of a selected person registration confirmation screen in the present embodiment;

FIG. 16 is an exemplary diagram illustrating an example of a person input screen in the present embodiment;

FIG. 17 is an exemplary diagram illustrating an example of a person registration confirmation screen in the present embodiment;

FIG. 18 is an exemplary diagram illustrating an example of a person's program information list screen in the present embodiment;

FIG. 19 is an exemplary diagram illustrating an example of a browser activation confirmation screen in the present embodiment;

FIG. 20 is an exemplary diagram illustrating an example of a program details screen in the present embodiment;

FIG. 21 is an exemplary diagram illustrating an example of a notification confirmation screen in the present embodiment;

FIGS. 22A and 22B are exemplary diagrams illustrating an example of a notification screen in the present embodiment; and

FIG. 23 is an exemplary flowchart illustrating the procedure of a badge display/update schedule registration process in the present embodiment.

### DETAILED DESCRIPTION

In general, according to one embodiment, an electronic device comprises an input controller to designate a plurality of first programs that a user wants to view among a plurality of programs; a processor to execute an application for displaying information on a first program to be broadcast in a first period among the plurality of the first programs, the first period being determined according to a current time; and a display processor to display number of first programs to be broadcast in the first period on a screen for activating the application.

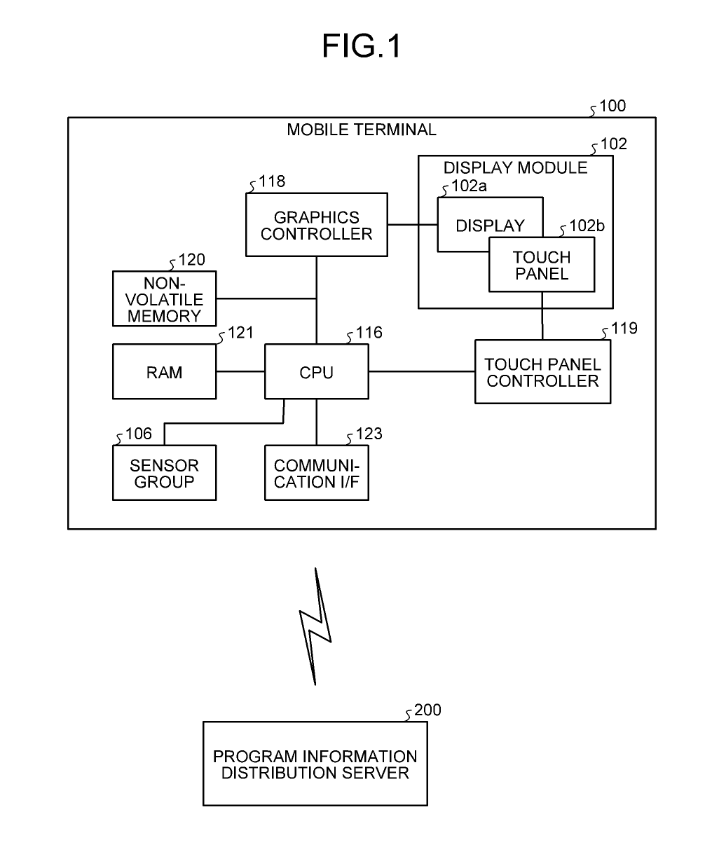

A program information distribution system of an embodiment is configured, as illustrated in FIG. 1, such that a mobile terminal 100 and a program information distribution server 200 are connected to a network such as the Internet.

The program information distribution server 200 is an information processing apparatus that manages program information including detailed information on a program scheduled to be broadcast and a broadcast start time of the program, and that distributes the program information to the mobile terminal 100. The mobile terminal 100 is an electronic device that receives the program information from the program information distribution server 200, and is realized as, for example, a mobile phone, a tablet terminal, a slate terminal, or the like.

As illustrated in FIG. 1, the mobile terminal 100 comprises a display module 102, a central processing unit (CPU) 116, a graphics controller 118, a touch panel controller 119, a non-volatile memory 120, a random access memory (RAM) 121, a communication I/F 123, a sensor group 106, and the like. In addition, the mobile terminal 100 may comprise a camera, a microphone, a speaker, and the like.

The display module 102 is configured as a so-called touch screen in which a display 102a and a touch panel 102b are combined. The display 102a is, for example, a liquid crystal display (LCD), an organic electro luminescence (EL) display, or the like. The touch panel 102b detects a position (touch position) on a display screen of the display 102a touched by a user's finger, a stylus pen, or the like.

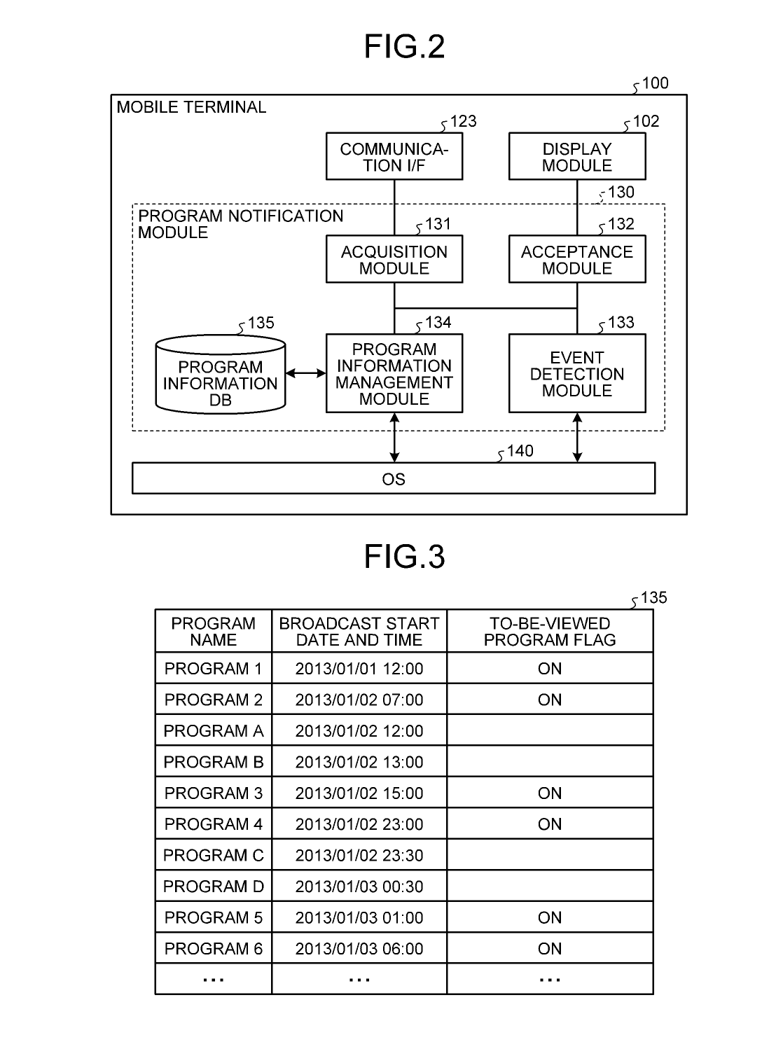

The non-volatile memory 120 stores therein an operating system, various application programs, various data needed to execute programs, and the like. The CPU 116 is a processor that controls operations of the mobile terminal 100, and controls each component of the mobile terminal 100. The CPU 116 executes the operating system and various application programs including a program notification application program, which are loaded from the non-volatile memory 120 to the RAM 121, to thereby realize each functional module to be described later (see FIG. 2). The RAM 121, as a main memory of the mobile terminal 100, provides a work area when the CPU 116 executes the programs.

The graphics controller 118 is a display controller that controls the display 102a of the display module 102. The touch panel controller 119 controls the touch panel 102b, and acquires coordinate data indicating a user's touch position from the touch panel 102b.

The communication I/F 123 performs wireless communication with the program information distribution server 200 or external devices and performs communication by a network such as the Internet, under control of the CPU 116.

The sensor group 106 is an acceleration sensor that detects a direction and a magnitude of external acceleration on the mobile terminal 100, an orientation sensor that detects an orientation of the mobile terminal 100, a gyro sensor that detects an angular velocity (angle of rotation) of the mobile terminal 100, or the like. A detection signal of each sensor is output to the CPU 116.

The mobile terminal 100 realizes each unit of a program notification module 130 and an operating system 140 (hereinafter, referred to as “the OS 140”) illustrated in FIG. 2 by cooperation of the CPU 116 and the programs (the operating system and various application programs such as the program notification application program) stored in the non-volatile memory 120.

The mobile terminal 100 according to the present embodiment comprises, as a functional configuration as illustrated in FIG. 2, the OS 140 and the program notification module 130. Incidentally, in FIG. 2, the communication I/F 123 and the display module 102 as described above are also illustrated.

The program notification module 130 comprises, as illustrated in FIG. 2, an acquisition module 131, an acceptance module 132, an event detection module 133, a program information management module 134, and a program information database 135 (hereinafter, referred to as “the program information DB 135”).

The program notification module 130 is realized when the CPU 116 executes the program notification application program stored in the non-volatile memory 120.

The program notification application program executed by the mobile terminal 100 of the present embodiment may be configured to be provided by being recorded in a computer-readable recording medium, such as a CD-ROM, a flexible disk (FD), a CD-R, or a digital versatile disk (DVD), as files in an installable format or an executable format.

Further, the program notification application program executed by the mobile terminal 100 of the present embodiment may be configured to be stored on a computer connected to a network such as the Internet and be provided by being downloaded via the network. Furthermore, the program notification application program executed by the mobile terminal 100 of the present embodiment may be configured to be provided or distributed via a network such as the Internet.

The acquisition module 131 acquires program information from the program information distribution server 200 via the communication I/F 123, and sends the acquired program information to the program information management module 134. The acquisition module 131 functions as a receiver. Further, the acquisition module 131 may be configured to acquire, from the program information distribution server 200, information (including detailed information) on a to-be-viewed program that is a program that a user wants to view.

The program information management module 134 registers and manages the program information acquired by the acquisition module 131 in the program information DB 135. The program information DB 135 is a database made up of a single or multiple pieces of program information. The program information DB 135 is stored in the non-volatile memory 120, the RAM 121, or the like.

FIG. 3 is a diagram illustrating an example of the program information DB 135 of the present embodiment. As illustrated in FIG. 3, a plurality of pieces of program information are registered in the program information DB 135. The program information is, as illustrated in FIG. 3, data in which a program name, a broadcast start date and time, and a to-be-viewed program flag are associated with one another. The to-be-viewed program flag is a flag indicating whether or not a program is a to-be-viewed program, and, if the to-be-viewed program flag is “ON”, this indicates that it is a to-be-viewed program. Incidentally, the to-be-viewed program is a program that a user wants to view among programs scheduled to be broadcast, and corresponds to a first program. The acceptance module 132 inputs, by a touch operation on the touch panel 102b by a user, a designation of whether or not a to-be-viewed program is among the programs displayed on the display 102a of the display module 102. The acceptance module 132 corresponds to an input controller.

Referring back to FIG. 2, the program information management module 134 classifies user's to-be-viewed programs in the program information registered in the program information DB 135, by broadcast start dates and times of the to-be-viewed programs for each one-day period that is a first period, and counts the number of to-be-viewed programs with broadcast start dates and times for broadcast in the one-day period. Subsequently, the program information management module 134 sends, to the OS 140, a command to display the counted number of the to-be-viewed programs (a to-be-viewed program number) to be broadcast in the one-day period (first period) on an activation icon of a program notification application. That is, the program information management module 134 causes the OS 140 to display the to-be-viewed program number on the activation icon of the program notification application. In this case, the program information management module 134 sends, to the OS 140, a command to, after a lapse of the one-day period (a first period), perform badge display of the number of to-be-viewed programs to be broadcast in a next one-day period (a next first period) starting at the end time of the one day on the activation icon of the program notification application.

Incidentally, the activation icon of the program notification application is an icon for activating various applications. The activation icon is displayed on the display 102a by being arranged on a screen capable of activating various applications.

Further, the program information management module 134 sends, to the OS 140, a command to decrement the to-be-viewed program number by one and display it on the activation icon of the program notification application every time a time of the broadcast start date and time of a to-be-viewed program that is broadcast in the one-day period (first period) has passed, in particular, a command to perform scheduling of to-be-viewed programs and broadcast start times of these programs. That is, the program information management module 134 causes the OS 140 to decrement the to-be-viewed program number by one and display it on the activation icon of the program notification application every time a time of the broadcast start date and time of a to-be-viewed program has passed.

The event detection module 133 detects, from the OS 140, events of activation and termination of the program notification application. Incidentally, the activation means that a program of the program notification application is executed. Further, the activation includes transition from a state (background execution state), in which the program of the program notification application is being executed but display is not performed on the display 102a of the mobile terminal 100 in which this program is installed, to a state (foreground execution state), in which display is performed on the display 102a. Furthermore, the termination similarly includes not only termination of execution of the program of the program notification application but also transition from the foreground execution state to the background execution state.

The OS 140 controls activation and termination of various application programs, and notifies the programs of events of user operations. Further, the OS 140 displays information on the display 102a of the display module 102 via the graphics controller 118. That is, the OS 140 accepts, from an application, a display timing and a value of the number to be displayed on an activation icon of the application, and controls them. In the present embodiment, upon reception of a command from the program information management module 134 that is the program notification application, the OS 140 displays the number of to-be-viewed programs with broadcast start dates and times for broadcast in a one-day period as the first period on the icon for activating the program notification application on the display 102a of the display module 102.

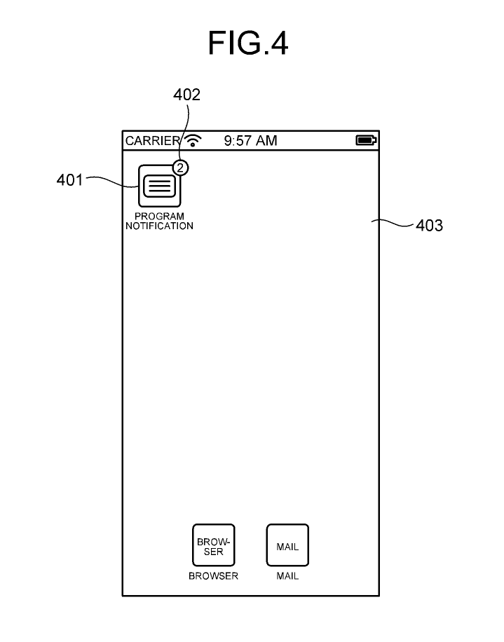

Incidentally, display of a value such as the number on the activation icon of the application is referred to as badge display. In the present embodiment, as illustrated in FIG. 4, an activation icon 401 of the program notification application is arranged on a screen 403 capable of activating the application. A to-be-viewed program number 402 is displayed as badge display on an upper right of the activation icon 401. Meanwhile, a display form of the to-be-viewed program number 402 on the activation icon is not limited to the example in FIG. 4, and display in an arbitrary form is possible.

Further, upon reception of a command from the program information management module 134, the OS 140 schedules the to-be-viewed programs to be broadcast at broadcast start times, and, every time a time of a broadcast start date and time of a to-be-viewed program to be broadcast in the one-day period has passed, decrements the to-be-viewed program number by one and performs badge display on the activation icon of the program notification application on the display 102a.

The OS 140 performs the above described display of the to-be-viewed program number for every one day that is the first period. That is, upon reception of a command from the program information management module 134, the OS 140, after a lapse of the one-day period (first period), displays the number of to-be-viewed programs to be broadcast in a next one-day period (next first period) starting at the end time of the one day on the activation icon of the program notification application. For example, 0:00, 5:00, or the like is set as the end time of one day, that is, as a date change time, and, at the date change time that is the end time, the OS 140 displays the number of to-be-viewed programs to be broadcast on a next day starting at the date change time on the activation icon of the program notification application.

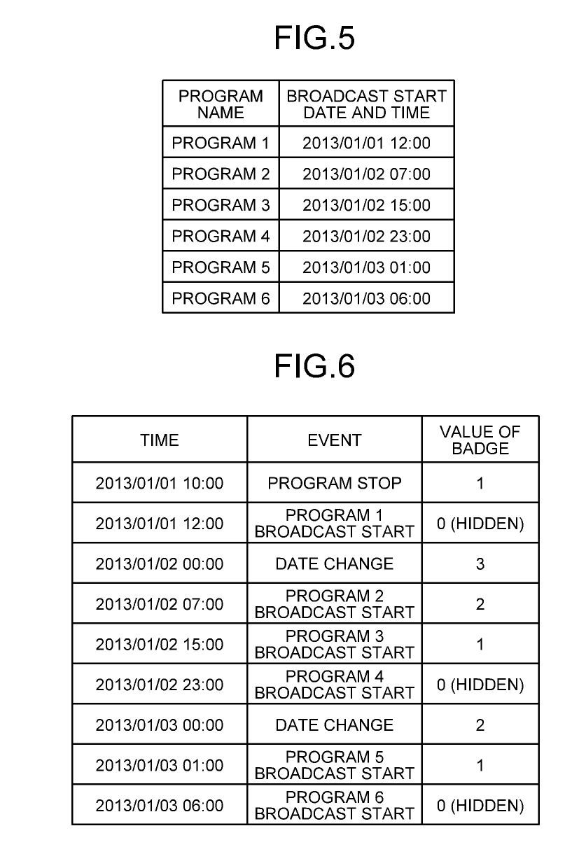

For example, a case will be described in which the to-be-viewed programs are registered as illustrated in the example in FIG. 3. The to-be-viewed programs registered in the program information DB 135 in the example in FIG. 3 are as illustrated in FIG. 5. In this case, by the program information management module 134 and the OS 140, the badge display of the number of to-be-viewed programs on the activation icon of the program notification application is changed as illustrated in FIG. 6.

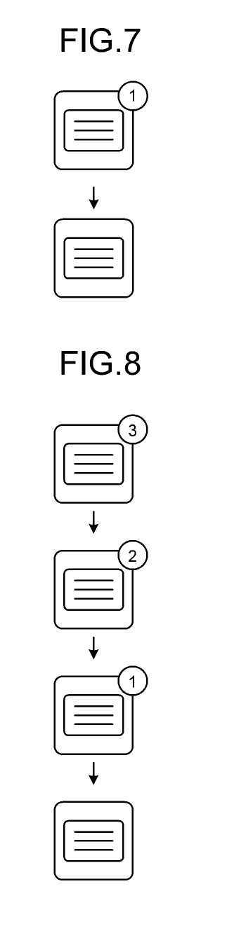

That is, as illustrated in FIG. 5, a to-be-viewed program on Jan. 1, 2013 is one that is a program 1 to be started to be broadcast at 12:00. Therefore, as illustrated in FIG. 6, the program information management module 134 and the OS 140 first perform badge display of “1” on the activation icon of the program notification application on Jan. 1, 2013, and when the broadcast of the program 1 starts at 12:00, the number of remaining to-be-viewed programs on Jan. 1, 2013 becomes zero, so that the badge display is hidden. FIG. 7 illustrates transition of the badge display on the activation icon of the program notification application on Jan. 1, 2013.

Further, as illustrated in FIG. 5, to-be-viewed programs on Jan. 2, 2013 are three, which are a program 2 to be started to be broadcast at 7:00, a program 3 to be started to be broadcast at 15:00, and a program 4 to be started to be broadcast at 23:00. Therefore, as illustrated in FIG. 6, the program information management module 134 and the OS 140 first perform badge display of “3” on the activation icon of the program notification application on Jan. 2, 2013, and when the broadcast of the program 2 starts at 7:00, the badge display is decremented by one to 2 because the number of remaining to-be-viewed programs on Jan. 2, 2013 at 7:00 becomes two.

Subsequently, when the broadcast of the program 3 starts at 15:00, the badge display is decremented by one to 1 because the number of remaining to-be-viewed programs on Jan. 2, 2013 at 15:00 becomes one. Further, when the broadcast of the program 4 starts at 23:00, the badge display is decremented by one to 0, that is, hidden, because the number of remaining to-be-viewed programs on Jan. 2, 2013 at 23:00 becomes zero. FIG. 8 illustrates transition of the badge display on the activation icon of the program notification application on Jan. 2, 2013. As for Jan. 3, 2013, the badge display changes to 2, 1, and hidden (0) in the same manner.

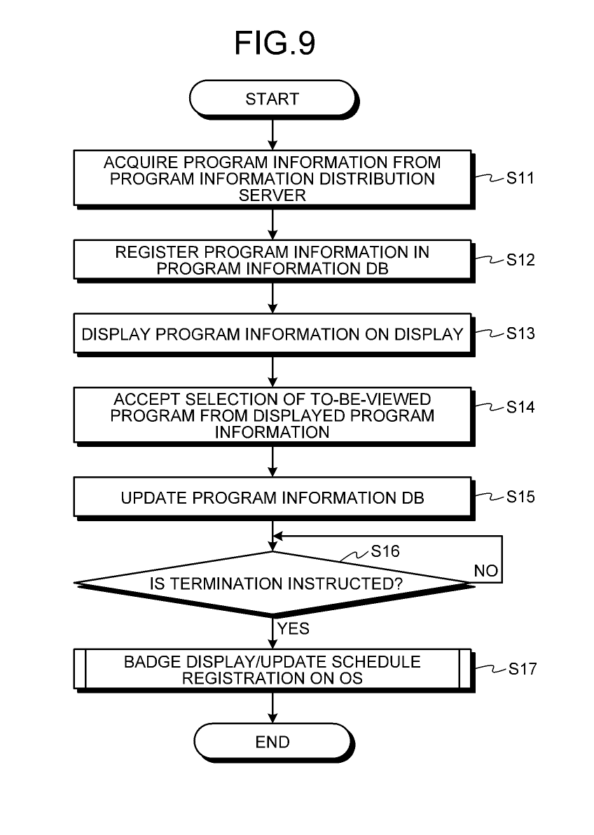

Next, a program notification process by the mobile terminal 100 of the present embodiment configured as described above will be described. First, a to-be-viewed program registration process of the present embodiment will be described with reference to FIG. 9.

When a user performs a touch operation on the activation icon of the program notification application displayed on the display 102a, the OS 140 activates the program notification application. Then, the event detection module 133 of the program notification module 130 notifies the program information management module 134 that the program of the program notification application is activated. The program information management module 134 receives this notice, and instructs the acquisition module 131 to acquire latest program information.

The acquisition module 131 acquires the latest program information from the program information distribution server 200 (S11). Incidentally, it may be configured not to acquire the latest program information from the program information distribution server 200 when only a predetermined time has elapsed since an acquisition time of previous program information or when an error such as a network connection failure has occurred in the acquisition module 131.

Subsequently, the program information management module 134 registers the program information acquired by the acquisition module 131 in the program information DB 135 (S12). Incidentally, the program information may be any information, and examples thereof include, but not limited to, information on a program in which a specific person appears and information on a program to be broadcast in a several days.

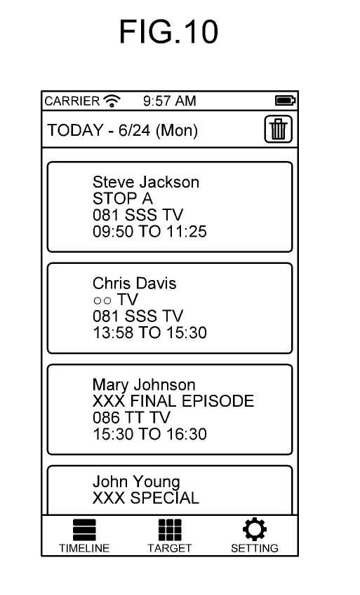

Subsequently, the program information management module 134 displays the program information registered in the program information DB 135 on the display 102a (S13). The program information management module 134 displays, for example, a program information list screen as illustrated in FIG. 10 on the display 102a. Incidentally, a display form of the program information is arbitrary, and, for example, listing in a chronological order of broadcast start times or listing according to each performer may be possible; however, it is not limited thereto.

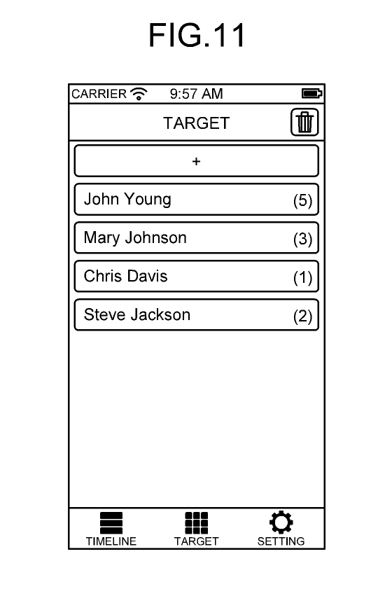

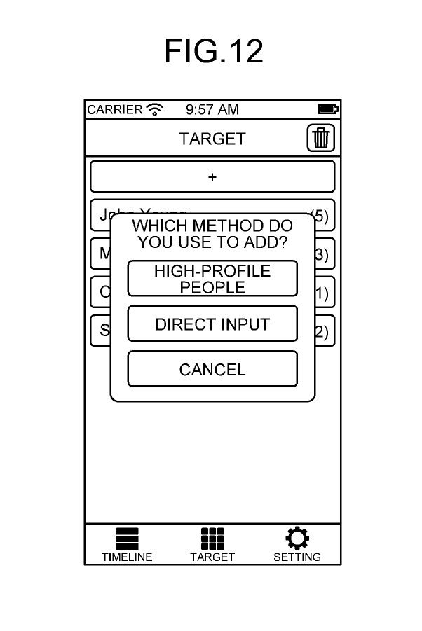

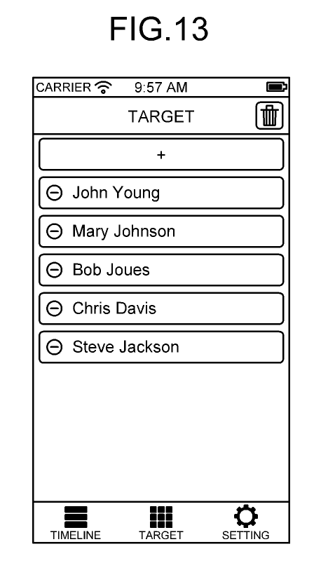

Further, for example, as illustrated in FIG. 11, the program information management module 134 may display a list of performers and the number of pieces of program information registered for each performer on a screen, select a performer on this screen, and display a list of pieces of program information on programs in which the selected performer appears. Furthermore, it may be possible to cause the program information management module 134 to display a screen illustrated in FIG. 12 when a user presses a “+” button in the screen in FIG. 11, cause the user to select a registered person adding method, and add a registered person by the selected method. Moreover, when deleting a registered person, the program information management module 134 displays a screen illustrated in FIG. 13 and causes the user to press a “−” button corresponding to a registered person that the user wants to delete.

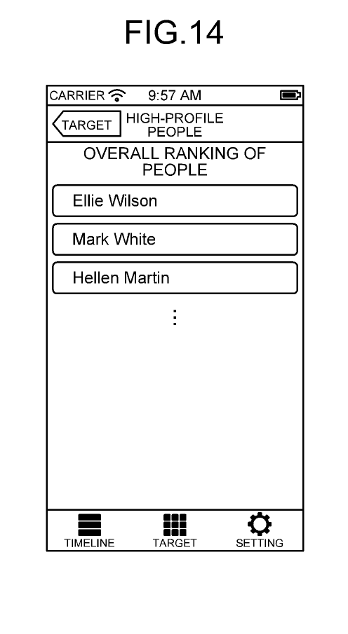

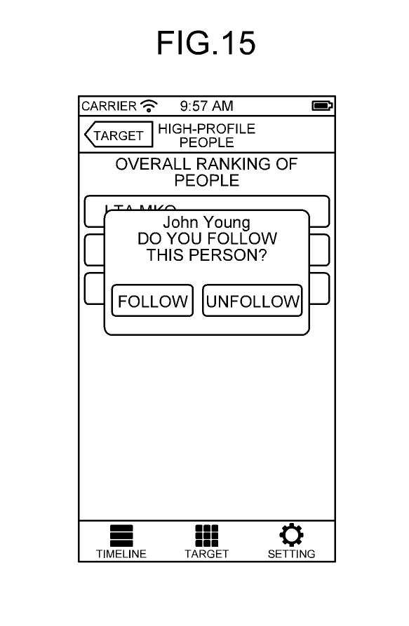

Furthermore, in the example in FIG. 12, two methods of “high-profile people” and “direct input” are provided as the registered person adding method. In the screen in FIG. 12, if a user selects “high-profile people”, the program information management module 134 acquires a list of high-profile people from an external server or the like, and displays a high-profile people list screen illustrated in FIG. 14. Then, the program information management module 134 causes the user to select a desired person from this screen, and displays a registration confirmation screen for the selected person as illustrated in FIG. 15. In the screen illustrated in FIG. 15, if the user presses “follow”, the program information management module 134 registers the selected person.

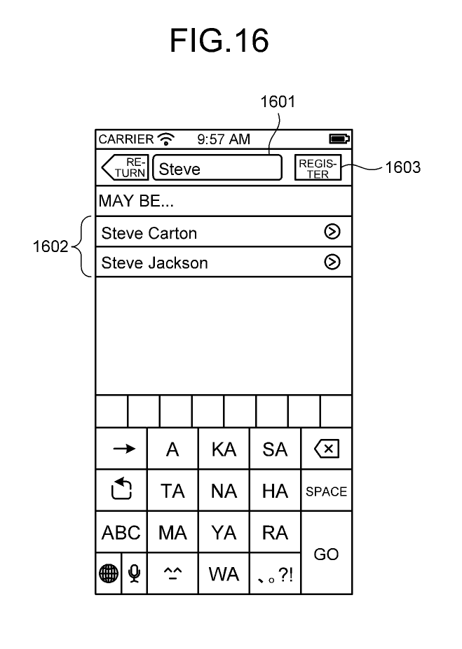

Moreover, in the screen in FIG. 12, if the user selects “direct input”, the program information management module 134 causes the user to directly input a person's name in an input screen illustrated in FIG. 16. The program information management module 134, by using the input person's name as a key, transmits program information on this person to the program information distribution server 200 via the communication I/F 123. The program information distribution server 200 searches for the received person's name through a people database in a server, and transmits retrieved information to the mobile terminal 100. The mobile terminal 100 acquires and displays the information on the person's name received from the program information distribution server 200.

In the example in FIG. 16, if the user inputs “Steve” in a text box 1601 in an upper part of the screen, the program information management module 134 transmits the input “Steve” to the program information distribution server 200. The program information distribution server 200 searches through the people database, and returns retrieved “Steve Carton” and “Steve Jackson”, as input completion candidates, to the mobile terminal 100. The program information management module 134 of the mobile terminal 100 displays an input completion candidate list 1602 (“Steve Carton” and “Steve Jackson”) received from the program information distribution server 200 on the display 102a as illustrated in FIG. 16.

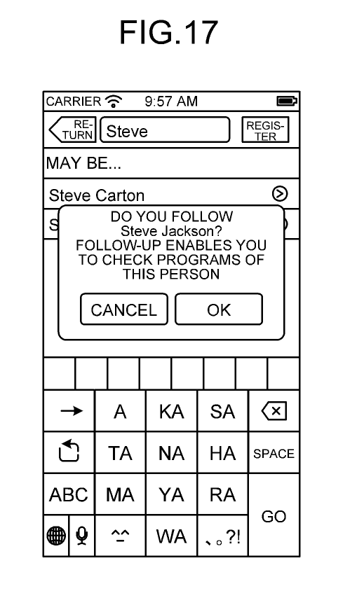

If, for example, the user selects “Steve Jackson” from the input completion candidate list 1602 illustrated in FIG. 16, the program information management module 134 displays the selected person's name of “Steve Jackson” in the text box 1601 in the upper part of the screen. Then, if the user presses a “registration” button 1603 on the right of the text box displaying the person's name of “Steve Jackson”, the program information management module 134 displays a registration confirmation screen for the selected person's name as illustrated in FIG. 17. If the user presses an “OK” button in the screen illustrated in FIG. 17, the program information management module 134 registers the selected person.

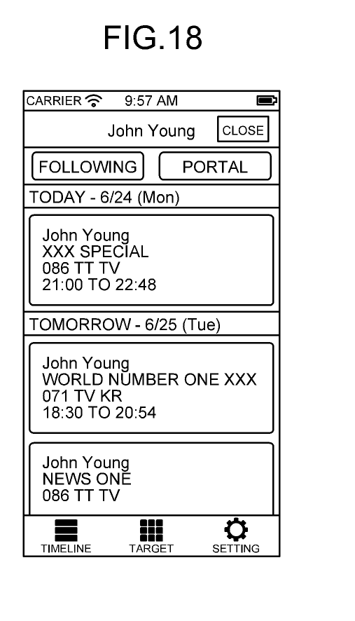

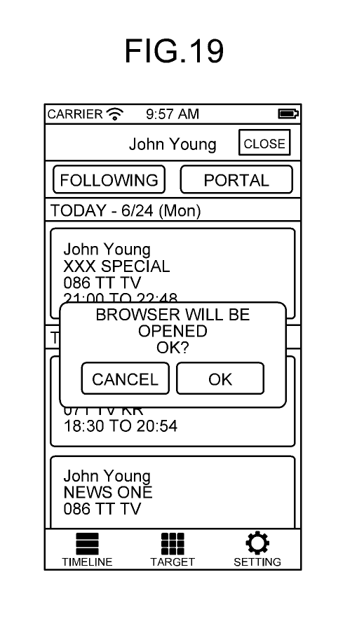

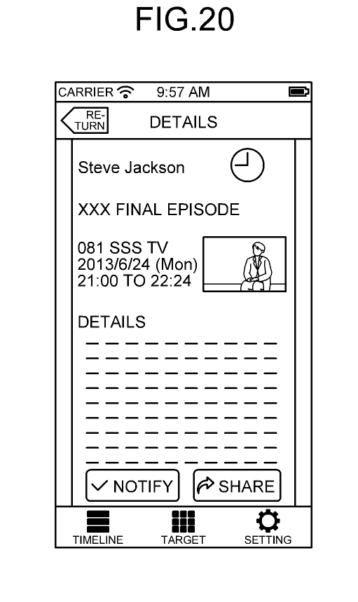

If a person is registered by these methods (“high-profile people” and “direct input” in FIG. 12), the program information management module 134 displays program information on the registered person on the display 102a as illustrated in FIG. 18. If the user selects a desired program in the screen illustrated in FIG. 18, a browser activation confirmation screen illustrated in FIG. 19 is displayed. If “OK” is pressed, the program information management module 134 displays a program details screen illustrated in FIG. 20 on the display 102a.

Referring back to FIG. 9, the user selects, as a to-be-viewed program, a desired program from the program information displayed on the display 102a as described above, and the acceptance module 132 accepts selection of the to-be-viewed program (S14). The acceptance module 132 notifies the program information management module 134 of the accepted to-be-viewed program, and the program information management module 134 sets a to-be-viewed program flag of program information corresponding to the to-be-viewed program in the program information DB 135 to ON to thereby update the program information DB 135 (S15).

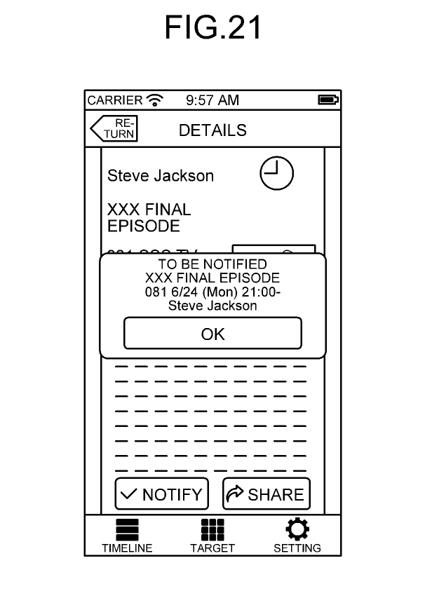

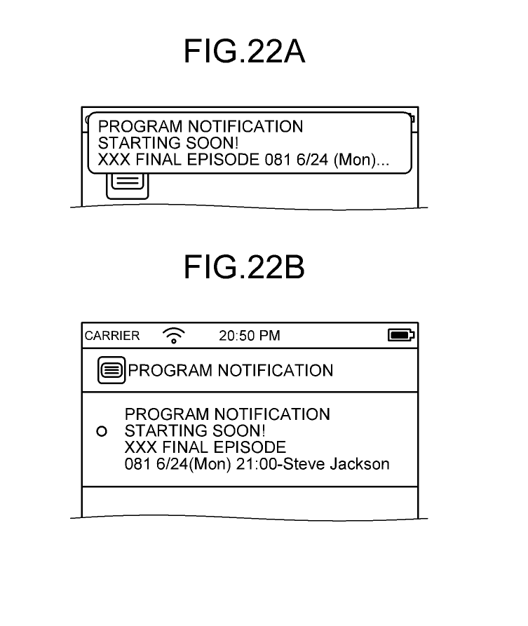

For example, in the screen illustrated in FIG. 20, if the user presses a “notify” button, the program information management module 134 displays a notification confirmation screen illustrated in FIG. 21, and, if the user presses an “OK” button in this screen, the corresponding program is registered as the to-be-viewed program. Incidentally, if a program is registered as the to-be-viewed program as described above, in addition to the badge display, start of the broadcast of the program is notified in a notification screen illustrated in FIGS. 22A and 22B at a broadcast start time, for example.

Subsequently, the event detection module 133 enters a state of waiting for detection of a program notification application termination event from the OS 140 (S16 and S16: No). Incidentally, a termination event of the program notification application is issued upon detection of an operation by the OS 140 when the user performs an operation of terminating execution of the program notification application or an operation of changing from a foreground execution state to a background execution state.

Then, if the event detection module 133 detects the termination event of the program notification application from the OS 140 (S16: Yes), the program information management module 134 performs a badge display/update schedule registration process on the OS 140 (S17).

Incidentally, the above described screens illustrated in FIG. 10 to FIGS. 22A and 22B are examples, and they are not limited thereto.

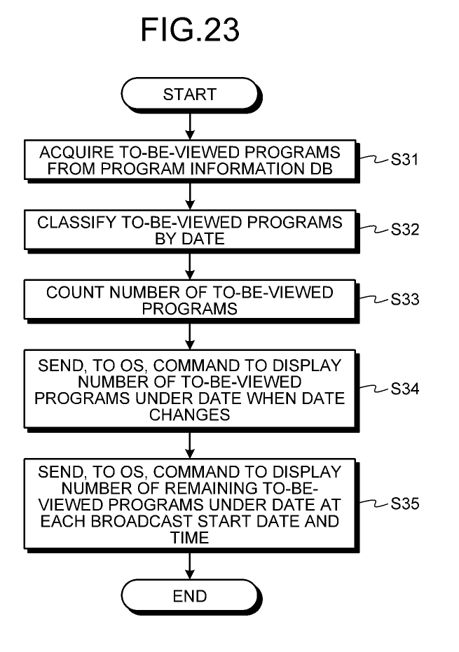

FIG. 23 is a flowchart illustrating the procedure of the badge display/update schedule registration process. First, the program information management module 134 acquires pieces of program information with to-be-viewed program flags of ON from the program information DB 135, to thereby acquire pieces of program information on to-be-viewed programs (S31).

Subsequently, the program information management module 134 classifies the acquired to-be-viewed programs by date of broadcast start dates and times in the pieces of the program information (S32). Then, the program information management module 134 counts the number of the to-be-viewed programs for each date (S33).

Subsequently, the program information management module 134 sends, to the OS 140, a command to perform badge display of the number of to-be-viewed programs on the activation icon of the program notification application when a date changes (S34). Further, the program information management module 134 sends, to the OS 140, a command to, after a lapse of the one-day period (first period), perform badge display of the number of to-be-viewed programs to be broadcast in a next one-day period (next first period) starting at the end time of the one day on the activation icon of the program notification application.

Furthermore, the program information management module 134 sends, to the OS 140, a command to, every time a time of each of the broadcast start dates and times has passed, perform badge display of the number of remaining to-be-viewed programs at this time on this day on the activation icon of the program notification application (S35).

Therefore, the OS 140 performs the badge display of the number of to-be-viewed programs on the activation icon of the program notification application when a date changes, and performs the badge display of the number of remaining to-be-viewed programs on the activation icon of the program notification application every time a time of each of the broadcast start dates and times has passed.

Conventionally, even when an application for notifying programs is installed in the mobile terminal 100, if there is no timing for a user to activate this application, it is difficult to recognize the presence of a to-be-viewed program. Further, even when the user receives a notice of a to-be-viewed program from the application, a notification timing may be so much earlier than a broadcast start time that the presence of the to-be-viewed program may be forgotten at its broadcast start time, or, a notification timing may be as late as just before a broadcast start time, so that the user may be unable to view.

In contrast, in the present embodiment, badge display of the number of to-be-viewed programs is performed on the activation icon of the program notification application when a date changes, and badge display of the number of remaining to-be-viewed programs on a day is performed on the activation icon of the program notification application every time each broadcast start date and time has passed.

Therefore, the user views a screen displaying the activation icon even when using functions other than the program notification application, and is able to recognize the number of to-be-viewed programs by viewing a value displayed on the activation icon every time the user views the screen displaying the activation icon. Consequently, according to the present embodiment, it is possible to accurately recognize the presence of a to-be-viewed program and to prevent the to-be-viewed program from not being viewed.

In the present embodiment, the number of to-be-viewed programs is displayed on the activation icon of the program notification application; however, as long as it is displayed on a screen capable of activating the application, it is not limited thereto. For example, if the OS 140 is Windows (registered trademark), it may be configured to display the number of to-be-viewed programs on a live tile displayed on a screen capable of activating the application. Further, if the OS 140 is Android (registered trademark), it may be configured to display the number of to-be-viewed programs on a widget.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an input controller to designate a plurality of first programs that a user wants to view among a plurality of programs;
a processor to execute an application for displaying information on a first program to be broadcast in a first period among the plurality of the first programs, the first period being determined according to a current time; and
a display processor to display number of first programs to be broadcast in the first period on a screen for activating the application.

2. The electronic device of claim 1, comprising the display processor to display the number on an icon for activating the application.

3. The electronic device of claim 1, comprising the display processor to decrement the number of the first programs to be broadcast in the first period by one every time when a broadcast time of one of the first programs to be broadcast in the first period has passed.

4. The electronic device of claim 1, comprising the display processor to display, after a lapse of the first period, number of first programs to be broadcast in a next first period that starts at an end time of the first period.

5. The electronic device of claim 1, further comprising:
a receiver to receive information on at least one first program from a server device.

6. The electronic device of claim 1, comprising the input controller to designate a plurality of first programs that a user wants to view on a screen displaying information on the plurality of the programs.

7. A display method comprising:
inputting a designation of a plurality of first programs that a user wants to view among a plurality of programs;
executing an application for displaying information on a first program to be broadcast in a first period among the plurality of the first programs, the first period being determined according to a current time; and
displaying number of first programs to be broadcast in the first period on a screen for activating the application.

8. The display method of claim 7, further comprising:
displaying the number on an icon for activating the application.

9. The display method of claim 7, further comprising:
decrementing the number of the first programs to be broadcast in the first period by one every time when a broadcast time of one of the first programs to be broadcast in the first period has passed.

10. The display method of claim 7, further comprising:
displaying, after a lapse of the first period, number of first programs to be broadcast in a next first period that starts at an end time of the first period.

11. The display method of claim 7, further comprising:
inputting a designation of a plurality of first programs that a user wants to view on a screen displaying information on the plurality of the programs.

12. A computer program product having a non-transitory computer readable medium including programmed instructions, wherein the instructions, when executed by a computer, cause the computer to perform:
inputting a designation of a plurality of first programs that a user wants to view among a plurality of programs;
displaying information on a first program to be broadcast in a first period among the plurality of the first programs, the first period being determined according to a current time; and
displaying number of first programs to be broadcast in the first period on a screen for activating the application.

13. The computer program product of claim 12, further comprising:
displaying the number on an icon for activating the application.

14. The computer program product of claim 12, further comprising:
decrementing the number of the first programs to be broadcast in the first period by one every time when a broadcast time of one of the first programs to be broadcast in the first period has passed.

15. The computer program product of claim 12, further comprising:
displaying, after a lapse of a first period, number of first programs to be broadcast in a next first period that starts at an end time of the first period.

16. The computer program product of claim 12, further comprising:
inputting a designation of a plurality of first programs that a user wants to view on a screen displaying information on the plurality of the programs.
